(19) United States
(12) Patent Application Publication
(10) Pub. No.: US 2023/0148494 A1
(43) Pub. Date: May 18, 2023

(54) Leaf Vacuum and Collection Canister

(71) Applicant: Robert Wilkes, St. Louis, MO (US)

(72) Inventor: Robert Wilkes, St. Louis, MO (US)

(21) Appl. No.: 17/986,806

(22) Filed: Nov. 14, 2022

Related U.S. Application Data
(60) Provisional application No. 63/279,632, filed on Nov. 15, 2021.

(51) Int. Cl. A01G 20/47

(52) U.S. Cl. CPC A01G 20/47

(57) ABSTRACT

Leaf Free provides users with an easier way to get rid of unwanted, fallen leaves. Specially designed to provide with battery or electric options, allowing for versatility for the user. The uniquely designed Leaf Free comes with an expandable hose, battery that last up to 4 hours, and an expandable bag with disposable liners. The ingenious canister with the expandable bag and disposable liner, snaps into place for ease of placement and removal. The Leaf Free also has glows in the dark features, helping you with removal during the shorter daytime hours of the fall season.

### CROSS REFERENCE

The present non-provisional patent application claims benefit to the priority date of the provisional application 63/279,632 under the same title filed Nov. 15, 2021 for Robert Wilkes in full inclusive by cross reference thereto.

### BACKGROUND

Fallen leaves are a typical part of yard maintenance. Having to clear them up, however, can be a lot of hard work and effort. Typically you need to rake the leaves into a pile and transfer them from the ground into trash bags to eliminate the fallen leaves from your yard. Some may also use a lawn mower to clean up or help blow the leaves away. Other options on the market would be leaf blowers to blow the leaves away, power rakes or some leaf suction apparatus. However, the current leaf suction devices still require you to transfer the leaves you have suctioned into the apparatus' bag into a disposable bag, and frequently the hose will clog up with the leaves your collecting. There have been no products available as original equipment or as an aftermarket to address this problem.

An apparatus to simplify the process of collection of fallen leaves from the ground and dispose of them with ease. There have been no products available as original equipment or as an aftermarket to address this problem either.

There exists a need for a device such as the Leaf Vacuum and Collection Canister, that is not being met by any known or disclosed device or system of present.

### SUMMARY OF THE INVENTION

Expanding on the initial design and concept, this ingenious and practical design of a leaf vacuum provides a simplified process of clearing of fallen leaves. The Leaf Vacuum offers a cordless option with a battery charge that lasts up to four hours. The Leaf Vacuum comes with an expandable hose, clip on canister, expandable bag with disposable liners and glow in the dark features.

A leaf maintenance device comprising includes a canister housing for a vacuum motor and an expandable liner therein, the canister configured to define a plurality of exhaust holes for vacuum exhaust to escape therefrom through the disposable liner. The disclosure also includes a timed throttle on the vacuum motor and configured to respond to a fuel level to the vacuum motor by a throttle of a power generated by the vacuum motor based on a predetermined run time. The disclosure additionally includes an expandable hose configured for an air and debris intake into the disposable liner in the canister.

The disclosure further includes an electro luminescence finish adjacent the exhaust holes and configured to photoelectrically respond to a static electricity generated by the expandable liner rubbing against the exhaust holes.

The disclosure yet includes a percentage fuel remaining determined by a sensed fuel level divided by a fuel capacity. A ran time of the vacuum motor is determined by a timer triggered by a start of the vacuum motor. A remaining run time of the vacuum motor is determined by subtracting the ran time from the predetermined run time. The throttle limits the vacuum motor to a one to one ratio of a percentage fuel remaining to a percentage run power during the remaining run time.

### BRIEF DESCRIPTION OF THE DRAWINGS

FIG. 1 is a front perspective view of the Leaf Vacuum and Collection Canister in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

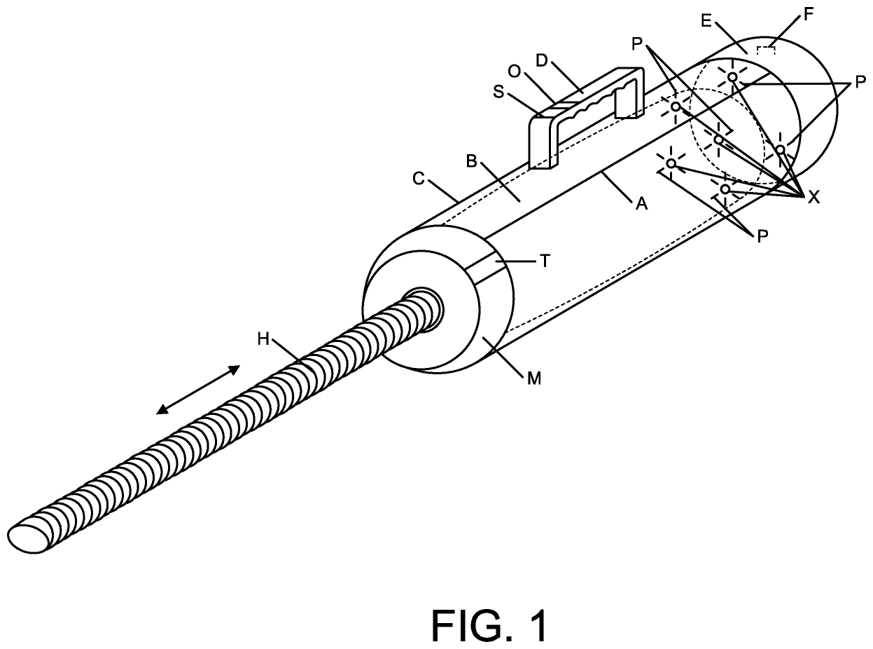

FIG. 1 is a front perspective view of the Leaf Vacuum and Collection Canister showing: Expandable hose referenced as H, Glow in the dark canister referenced as C, Expandable bag with disposable liner referenced as B, Handle referenced as D., Rechargeable battery compartment or gas tank referenced as E., Charging port or gas cap referenced as F, vacuum motor M, switch S, throttle T, exhaust ports or holes X, electro luminescence P, door access A and override O as a throttle override in accordance with an embodiment of the present disclosure.

The present disclosed Leaf Vacuum and Collection Canister, also known as “Leaf Free”, provides users with an easier way to suck up unwanted leaves. The leaf vacuum comes with both battery or electric options allowing for versatility for the user. The battery provided has a charge that lasts up to four hours. The apparatus is designed to either be handheld or pulled around with you. The special designed hose is expandable which is helpful to prevent clogs in the hose line from wet leaves or other debris. Leaf Free also comes with an expandable bag with a disposable liner. This disposable liner saves time clearing up leaves, fast and efficiently, without having to clear them out of a regular vacuum bag or by hand. The ingenious canister with the expandable bag and disposable liner, snaps into place for ease of placement and removal. The Leaf Free also glows in the dark, helping you with removal during the shorter daytime hours of the fall season.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A leaf maintenance device comprising:
a canister housing for a vacuum motor and an expandable liner therein, the canister configured to define a plurality of exhaust holes for vacuum exhaust to escape therefrom through the disposable liner;
a timed throttle on the vacuum motor and configured to respond to a fuel level to the vacuum motor by a throttle of a power generated by the vacuum motor based on a predetermined run time; and
an expandable hose configured for an air and debris intake into the disposable liner in the canister;

2. The leaf maintenance device of claim 1, wherein the canister comprises a glow in the dark electro luminescent finish.

3. The leaf maintenance device of claim 1, further comprising an electro luminescence finish adjacent the exhaust holes and configured to photoelectrically respond to a static electricity generated by the expandable liner rubbing against the exhaust holes.

4. The leaf maintenance device of claim 1, wherein the expandable liner is disposable.

5. The leaf maintenance device of claim 1, further comprising a handle attached to the canister and comprising a throttled on/off switch for the vacuum motor.

6. The leaf maintenance device of claim 1, wherein the vacuum motor is electric and the throttle is electric.

7. The leaf maintenance device of claim 1, wherein the vacuum motor is gasoline and the throttle is a valve on a gasoline input to the vacuum motor from a tank adjacent the canister.

8. The leaf maintenance device of claim 1, further comprising a predetermined run time switch configured to set a variable run time of the vacuum motor.

9. The leaf maintenance device of claim 1, further comprising a gasoline gauge on a gasoline input to the vacuum motor and configured to communicate a remaining gasoline amount to the throttle.

10. The leaf maintenance device of claim 1, further comprising a battery gauge on an electric battery on the canister and configured to communicate a remaining electrical charge amount to the throttle.

11. The leaf maintenance device of claim 1, further comprising a half canister door defined in the canister and configured to enable access to the expandable liner therein.

12. The leaf maintenance device of claim 1, wherein the canister comprises a transparent material configured to enable viewing a filling of the expandable liner.

13. The leaf maintenance device of claim 1, further comprising a throttle override switch on a handle of the canister.

14. The leaf maintenance device of claim 1, wherein the predetermined run time is four hours.

15. The leaf maintenance device of claim 1, further comprising a percentage fuel remaining determined by a sensed fuel level divided by a fuel capacity.

16. The leaf maintenance device of claim 15, further comprising a ran time of the vacuum motor determined by a timer triggered by a start of the vacuum motor.

17. The leaf maintenance device of claim 16, further comprising a remaining run time of the vacuum motor determined by subtracting the ran time from the predetermined run time.

18. The leaf maintenance device of claim 17, wherein the throttle limits the vacuum motor to a one to one ratio of a percentage fuel remaining to a percentage run power during the remaining run time.
